(19) United States
(12) Patent Application Publication
(10) Pub. No.: US 2025/0372303 A1
(43) Pub. Date: Dec. 4, 2025

(54) CAPACITOR, ELECTRICAL CIRCUIT, CIRCUIT BOARD, DEVICE, AND DIELECTRIC MATERIAL FOR CAPACITOR

(71) Applicant: Panasonic Intellectual Property Management Co., Ltd., Osaka (JP)

(72) Inventors: TAKAYA UENO, Osaka (JP); TOMOYASU YOKOYAMA, Osaka (JP); KOSEI OHURA, Osaka (JP)

(21) Appl. No.: 19/299,222

(22) Filed: Aug. 13, 2025

Related U.S. Application Data
(63) Continuation of application No. PCT/JP2024/006152, filed on Feb. 21, 2024.

(30) Foreign Application Priority Data
Mar. 3, 2023 (JP) 2023-033158

(51) Int. Cl. H01G 4/10; H01G 4/005; H01G 4/20; H01G 4/40

(52) U.S. Cl. CPC H01G 4/10; H01G 4/005; H01G 4/20; H01G 4/40

(57) ABSTRACT

The present disclosure provides a capacitor that is advantageous in terms of a capacitance and a dielectric breakdown field. According to the present disclosure, a capacitor comprises a first electrode, a second electrode, and a dielectric material. The dielectric material is disposed between the first electrode and the second electrode. The dielectric material comprises a composite oxide. The composite oxide is composed of O, Cs, W, and at least one selected from the group consisting of Ti, Zr, and Hf.

### BACKGROUND

### 1. Technical Field

The present disclosure relates to a capacitor and a dielectric material for the capacitor and also relates to an electrical circuit, a circuit board, and a device.

### 2. Description of the Related Art

In the related art, dielectric materials containing a composite oxide are known.

For example, PTL 1 describes an integrated circuit including a non-ferroelectric high-dielectric-constant insulator. This insulator includes a thin film of a metal oxide. One of the described metal oxides is a pyrochlore-type oxide having a general formula of A₂B₂O₇. A represents an A-site atom selected from a metal group consisting of Ba, Bi, Sr, Pb, Ca, K, Na, and La. B represents a B-site atom selected from a metal group consisting of Ti, Zr, Ta, Hf, Mo, W, and Nb.

NPL 1 describes dielectric properties of Nd₂Hf₂O₇ which is a pyrochlore-type crystal.

NPL2 describes improvement of a BaTa₂O₆ thin film in order to use the film as a gate insulator of a thin film transistor (TFT). NPL2 describes variations in a dielectric constant of the BaTa₂O₆ thin film with respect to oxygen partial pressures.

NPL3 describes a measurement result of a dielectric constant of a BaNb₂O₆ thin film.

### CITATION LIST

### Patent Literature

PTL 1: Japanese Unexamined Patent Application Publication (Translation of PCT Application) No. 2003-502837

### Non-Patent Literature

NPL 1: J. Chun et al., “Promising high-k dielectric permittivity of pyrochlore-type crystals of Nd₂Hf₂O₇”, Journal of Materials Chemistry C, 2015, 3, 491-494

NPL 2: Son Bui Tien et al., “Improvement of BaTa₂O₆ Thin Films for TFT Gate Insulator Applications”, The 66th JSAP Spring Meeting, 2019

NPL 3: D. W. KIM et al., “Crystallographic orientation dependence of the dielectric constant in polymorphic BaTa₂O₆ thin films deposited laser ablation”, Phys. A 79, 677-680 (2004)

### SUMMARY

The technologies described in the above-mentioned literatures have room for further study in terms of a capacitance and a dielectric breakdown field of a capacitor that uses a dielectric material containing a composite oxide.

One non-limiting and exemplary embodiment provides a capacitor that uses a dielectric material containing a composite oxide and which is advantageous in terms of a capacitance and a dielectric breakdown field.

In one general aspect, the techniques disclosed here feature a capacitor comprising a first electrode, a second electrode, and a dielectric material disposed between the first electrode and the second electrode, the dielectric material comprising a composite oxide, wherein the composite oxide is composed of O, Cs, W, and at least one selected from the group consisting of Ti, Zr, and Hf.

The present disclosure provides a capacitor that uses a dielectric material containing a composite oxide and which is advantageous in terms of a capacitance and a dielectric breakdown field. Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view illustrating an exemplary capacitor of the present disclosure;

FIG. 2 is a cross-sectional view illustrating another exemplary capacitor of the present disclosure;

FIG. 3 is a cross-sectional view illustrating yet another exemplary capacitor of the present disclosure;

FIG. 4 is a cross-sectional view illustrating still another exemplary capacitor of the present disclosure;

FIG. 5 is a schematic diagram illustrating an exemplary electrical circuit of the present disclosure;

FIG. 6 is a schematic diagram illustrating an exemplary circuit board of the present disclosure;

FIG. 7 is a schematic diagram illustrating an exemplary device of the present disclosure;

FIG. 8 is a schematic diagram illustrating a manner of evaluating a relative dielectric constant of dielectric materials of Examples; and

FIG. 9 is a graph showing X-ray diffraction (XRD) patterns of dielectric materials of Examples 1, 2, and 3.

### DETAILED DESCRIPTIONS

### Underlying Knowledge Forming Basis of the Present Disclosure

In the related art, regarding capacitors including a dielectric material containing a composite oxide, studies have been conducted on the combination of elements that are included in the composite oxide. In PTL 1, for example, the A-site atom in a pyrochlore-type oxide having a general formula of A₂B₂O₇ is selected from a metal group consisting of Ba, Bi, Sr, Pb, Ca, K, Na, and La. In addition, the B-site atom in the pyrochlore-type oxide is selected from a metal group consisting of Ti, Zr, Ta, Hf, Mo, W, and Nb. The pyrochlore-type oxide disclosed in PTL 1 is a composite oxide represented by (BaₓSr₁₋ₓ)₂(Ta_{y}Nb_{1-y})₂O₇, where the conditions of 0≤x≤1.0 and 0≤y≤1.0 are satisfied. The metal oxide materials described in PTL 1 have a relatively high dielectric constant and are used in integrated circuits.

Regarding the characteristics of capacitors, a high dielectric constant of the dielectric material is important from the standpoint of the capacitance of the capacitors, and a dielectric breakdown field is also important; the dielectric breakdown field is an upper limit of an electric field that can be applied to the dielectric material.

Accordingly, the present inventors diligently conducted studies to develop a capacitor that is advantageous in terms of a high capacitance and a high dielectric breakdown field. As a result, it was newly discovered that in instances where a dielectric material containing a composite oxide formed of a combination of elements that is not described in the above-mentioned literatures is used in a capacitor, the capacitor is likely to have a high capacitance and may have a high dielectric breakdown field. Based on this new discovery, the present inventors invented the capacitor of the present disclosure.

### Embodiments of the Present Disclosure

Embodiments of the present disclosure will be described below with reference to the drawings.

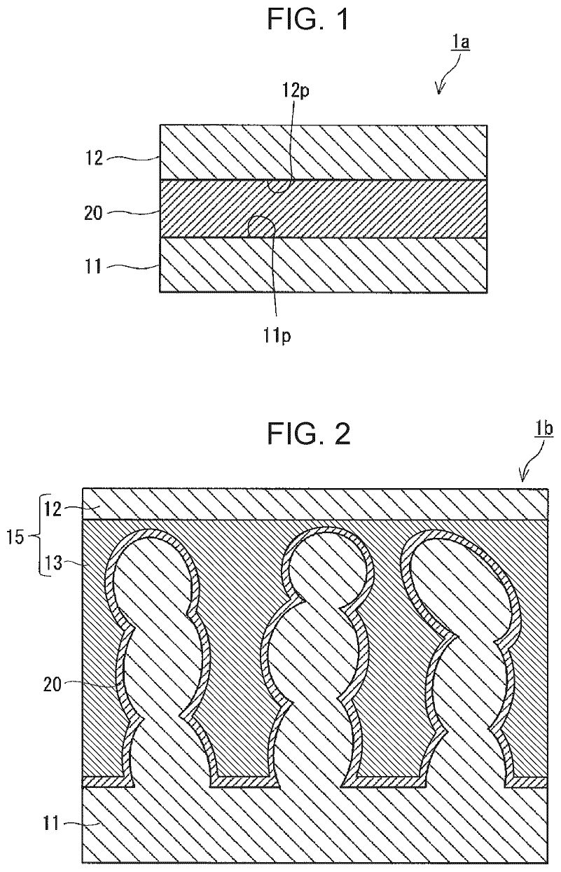

FIG. 1 is a cross-sectional view illustrating an exemplary capacitor of the present disclosure. As illustrated in FIG. 1, a capacitor 1a includes a first electrode 11, a second electrode 12, and a dielectric material 20. The dielectric material 20 is disposed between the first electrode 11 and the second electrode 12. The dielectric material 20 contains a predetermined composite oxide. The composite oxide is composed of O, Cs, W, and at least one selected from the group consisting of Ti, Zr, and Hf. Since the dielectric material 20 contains such a composite oxide, the dielectric material 20 is likely to have a high relative dielectric constant, which makes it likely that the capacitor 1a has a high capacitance. In addition, the dielectric material 20 is likely to have a high dielectric breakdown field. Consequently, the capacitor 1a is likely to have an increased energy density. The composite oxide may contain trace amounts of impurities. The trace amounts of impurities may be composed of O elemental species other than the elemental species mentioned above. The trace amounts of impurities may be present, for example, in an amount less than or equal to 5 mass % based on the total mass of the composite oxide.

The composition of the composite oxide is not limited to any particular composition as long as the composition is composed of O, Cs, W, and at least one selected from the group consisting of Ti, Zr, and Hf. For example, the composite oxide has a composition represented by Cs_{α}X_{β}W_{γ}O_{δ}. In this composition, X is at least one selected from the group consisting of Ti, Zr, and Hf. This composition satisfies conditions of 0.9≤α≤1.1, 0.25≤β≤1, 1≤γ≤2, and 5.5≤δ≤6.5. In the case where the composite oxide has such a composition, the dielectric material 20 is likely to have a higher relative dielectric constant, and the dielectric material 20 is likely to have a higher dielectric breakdown field.

The composition may satisfy a condition of α=1. The composition may satisfy a condition of 0.3≤β≤0.9, 0.3≤β≤0.8, 0.3≤β≤0.7, 0.3 ≤β≤0.6, 0.4≤β≤0.6, or β=0.5. The composition may satisfy a condition of γ=1.5. The composition may satisfy a condition of δ=6.

The crystal structure of the composite oxide is not limited to a particular crystal structure. For example, the composite oxide has a pyrochlore-type crystal structure. In this case, the dielectric material 20 is likely to have a higher relative dielectric constant, and the dielectric material 20 is likely to have a higher dielectric breakdown field.

The entirety of the dielectric material 20 may be formed of the composite oxide, or a portion of the dielectric material 20 may be formed of the composite oxide. In the dielectric material 20, the composite oxide may be in the form of a continuous phase or a dispersed phase.

The relative dielectric constant of the dielectric material 20 is not limited to any particular value. A relative dielectric constant at room temperature of the dielectric material 20, at 1 MHz, may be greater than 50, greater than or equal to 55, greater than or equal to 60, greater than or equal to 70, greater than or equal to 80, or greater than or equal to 100. The room temperature is, for example, a specific temperature within a range of 20° C. to 25° C. The relative dielectric constant at room temperature of the dielectric material 20, at 1 MHz, is, for example, less than or equal to 10,000. In other words, the relative dielectric constant at room temperature of the dielectric material 20, at 1 MHz, is, for example, greater than or equal to 55 and less than or equal to 10,000.

The dielectric breakdown field of the dielectric material 20 is not limited to any particular value. A dielectric breakdown field at −273° C. of the dielectric material 20 is, for example, greater than or equal to 0.1 V/nm and may be greater than or equal to 5 V/nm or greater than or equal to 10 V/nm. The dielectric breakdown field at −273° C. of the dielectric material 20 is, for example, less than or equal to 50 V/nm. In other words, the dielectric breakdown field at −273° C. of the dielectric material 20 may be greater than or equal to 10 V/nm and less than or equal to 30 V/nm.

In the capacitor 1a, the dielectric material 20 is in the form of, for example, a film, as illustrated in FIG. 1. The method for placing the dielectric material 20 into the capacitor la is not limited to a particular process. For example, the dielectric material 20 may be formed by spin coating, ink jetting, die coating, roll coating, bar coating, Langmuir-Blodgett technique, dip coating, or spray coating. In this case, the dielectric material 20 is more likely to have a high relative dielectric constant, and the dielectric material 20 is likely to have a higher dielectric breakdown field. The dielectric material 20 may be formed by sputtering, anodizing, vacuum vapor deposition, pulsed laser deposition (PLD), atomic layer deposition (ALD), or chemical vapor deposition (CVD).

As illustrated in FIG. 1, the dielectric material 20 is disposed, for example, between the first electrode 11 and the second electrode 12 in a thickness direction of the dielectric material 20. The second electrode 12 covers, for example, at least a portion of the dielectric material 20.

Each of the materials of the first electrode 11 and the second electrode 12 is not limited to a particular material. For example, the first electrode 11 and the second electrode 12 each contain a metal. The first electrode 11 contains, for example, a valve metal. Examples of the valve metal include Al, Ta, Nb, and Bi. For example, the first electrode 11 contains, as the valve metal, at least one selected from the group consisting of Al, Ta, Nb, and Bi. The first electrode 11 may contain a precious metal, such as gold or platinum. The first electrode 11 may contain Ni. The first electrode 11 may contain a metal element of Group 13, 14, or 15.

The second electrode 12 may, for example, contain a valve metal, such as Al, Ta, Nb, or Bi, contain a precious metal, such as gold, silver, or platinum. The second electrode 12 may contain Ni. The second electrode 12 may contain a metal element of Group 13, 14, or 15. The second electrode 12 contains, for example, at least one selected from the group consisting of Al, Ta, Nb, Bi, gold, silver, platinum, and Ni.

As illustrated in FIG. 1, the first electrode 11 has a principal surface 11p. One of the principal surfaces of the dielectric material 20 is, for example, in contact with the principal surface 11p. The second electrode 12 has a principal surface 12p which is, for example, parallel to the principal surface 11p. The other principal surface of the dielectric material 20 is, for example, in contact with the principal surface 12p.

FIG. 2 is a cross-sectional view illustrating another exemplary capacitor of the present disclosure. A capacitor 1b illustrated in FIG. 2 has a configuration similar to that of the capacitor 1a, except for portions that are particularly described. Constituent elements of the capacitor 1b that are the same as or correspond to the constituent elements of the capacitor 1a are assigned the same reference numerals, and details thereof will not be described. The descriptions of the capacitor 1a apply to the capacitor 1b as long as there is no technical inconsistency. The same applies to a capacitor 1c and a capacitor 1d, which will be described below.

As illustrated in FIG. 2, the capacitor 1b is an electrolytic capacitor. In the capacitor 1b, at least a portion of the first electrode 11 is porous. With this configuration, the first electrode 11 is likely to have a large surface area, which makes it more likely that the capacitor 1b has a high capacitance. Such a porous structure can be formed by any of the processes including, for example, etching of metal foil and powder sintering processes.

As illustrated in FIG. 2, the film of the dielectric material 20 is disposed, for example, on the surface of the porous portions of the first electrode 11. Examples of processes for forming the dielectric material 20 that can be employed include spin coating, ink jetting, die coating, roll coating, bar coating, Langmuir-Blodgett technique, dip coating, and spray coating. The dielectric material 20 may be formed, for example, by sputtering, anodizing, vacuum vapor deposition, PLD, ALD, or CVD.

The first electrode 11 contains, for example, a valve metal, such as Al, Ta, Nb, Zr, Hf, and Bi. The second electrode 12 may contain, for example, a solidified product of a silver-containing paste; a carbon material, such as graphite; or both the solidified product of the silver-containing paste and the carbon material, such as graphite.

In the capacitor 1b, an electrolyte 13 is disposed between the first electrode 11 and the second electrode 12. Specifically, the electrolyte 13 is disposed between the dielectric material 20 and the second electrode 12. In the capacitor 1b, for example, the second electrode 12 and the electrolyte 13 constitute a cathode 15. In the capacitor 1b, the electrolyte 13 is disposed, for example, to fill a space around the porous portions of the first electrode 11.

The electrolyte 13 includes, for example, at least one selected from the group consisting of an electrolyte solution and a conductive polymer. Examples of the conductive polymers include polypyrrole, polythiophene, polyaniline, and derivatives thereof. The electrolyte 13 may be a manganese compound, such as manganese oxide. The electrolyte 13 may contain a solid electrolyte.

The electrolyte 13 containing a conductive polymer can be formed by polymerizing a raw material monomer on the dielectric material 20 by performing chemical polymerization, electrolytic polymerization, or both chemical polymerization and electrolytic polymerization. The electrolyte 13 containing a conductive polymer can also be formed by disposing a solution or dispersion of a conductive polymer onto the dielectric material 20.

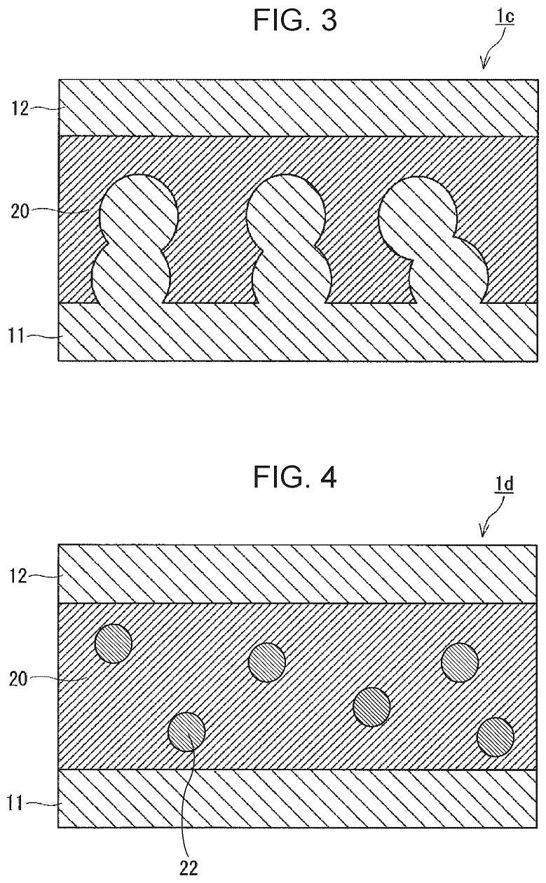

FIG. 3 is a cross-sectional view illustrating yet another exemplary capacitor of the present disclosure. In a capacitor 1c, illustrated in FIG. 3, at least a portion of the first electrode 11 is porous. With this configuration, the first electrode 11 is likely to have a large surface area, which makes it more likely that the capacitor 1c has a high capacitance. Such a porous structure can be formed by any of the processes including, for example, etching of metal foil and powder sintering processes.

As illustrated in FIG. 3, the film of the dielectric material 20 is disposed, for example, on an upper part of the porous portions of the first electrode 11. Examples of processes for forming the dielectric material 20 that can be employed include spin coating, ink jetting, die coating, roll coating, bar coating, Langmuir-Blodgett technique, dip coating, and spray coating. In the capacitor 1c, the dielectric material 20 is disposed, for example, to fill a space around the porous portions of the first electrode 11.

FIG. 4 is a cross-sectional view illustrating still another exemplary capacitor of the present disclosure. In a capacitor 1d, illustrated in FIG. 4, the dielectric material 20 is in the form of, for example, a film. In this film, a different dielectric material 22 which is different from the dielectric material 20 is disposed in a dispersed manner. A process that can be employed to form the film is spin coating, ink jetting, die coating, roll coating, bar coating, Langmuir-Blodgett technique, dip coating, or spray coating. The film including the dielectric material 20 and the different dielectric material 22 can be obtained, for example, by forming, with any of the above-mentioned processes, a coating of a precursor liquid containing the raw material of the dielectric material 20 and particles of the different dielectric material 22. The film may be formed by sputtering, anodizing, vacuum vapor deposition, PLD, ALD, or CVD.

The different dielectric material 22 is not limited to any particular dielectric material as long as it is a type of dielectric material different from the dielectric material 20. The different dielectric material 22 has, for example, a higher relative dielectric constant than the dielectric material 20. The different dielectric material 22 may be a perovskite compound, for example, such as BaTiO₃, PbTiO₃, or SrTiO₃. The different dielectric material 22 may be a layered perovskite compound. The different dielectric material 22 may include at least one selected from the group consisting of Ruddlesden-Popper compounds, Dion-Jacobson compounds, tungsten bronze compounds, and pyrochlore compounds.

The size of the particles of the different dielectric material 22 is not limited to a particular value. The particles of the different dielectric material 22 have a size of, for example, greater than or equal to 1 nm and less than or equal to 100 nm.

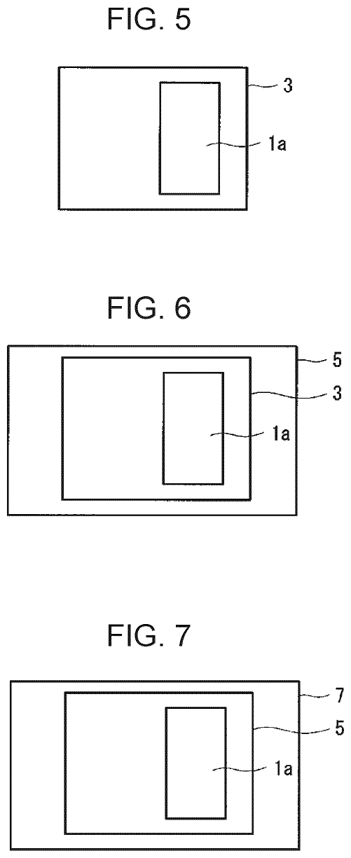

FIG. 5 is a schematic diagram illustrating an exemplary electrical circuit of the present disclosure. An electrical circuit 3 includes the capacitor 1a. The electrical circuit 3 may be an active circuit or a passive circuit. The electrical circuit 3 may be a discharge circuit, a smoothing circuit, a decoupling circuit, or a coupling circuit. Since the electrical circuit 3 comprises the capacitor 1a, the electrical circuit 3 easily exhibit desired properties. For example, the capacitor 1a facilitates reducing noise in the electrical circuit 3. The electrical circuit 3 may include the capacitor 1b, the capacitor 1c, or the capacitor 1d in place of the capacitor 1a.

FIG. 6 is a schematic diagram illustrating an exemplary circuit board of the present disclosure. As illustrated in FIG. 6, a circuit board 5 includes the capacitor 1a. For example, the electrical circuit 3 including the capacitor 1a is formed on the circuit board 5. The circuit board 5 may be an embedded board or a motherboard. The circuit board 5 may include the capacitor 1b, the capacitor 1c, or the capacitor 1d in place of the capacitor 1a.

FIG. 7 is a schematic diagram illustrating an exemplary device of the present disclosure. As illustrated in FIG. 7, a device 7 includes, for example, the capacitor 1a. The device 7 includes, for example, the circuit board 5 including the capacitor 1a. Since the device 7 comprises the capacitor 1a, the device 7 easily exhibits desired properties. The device 7 may be an electronic device, a communication device, a signal processing device, or a power supply device. The device 7 may be a server, an AC adapter, an accelerator, or a flat panel display, such as a liquid crystal display device (LCD). The device 7 may be a USB charger, a solid stated drive (SSD), an information terminal, such as a PC, a smartphone, or a tablet PC, or an ethernet switch.

### SUPPLEMENTARY NOTES

According to what has been described above, the following technologies are disclosed.

(Technology 1) A capacitor comprising:
a first electrode;
a second electrode; and
a dielectric material disposed between the first electrode and the second electrode, the dielectric material comprising a composite oxide, wherein
the composite oxide is composed of:
O,
Cs,
W, and
at least one selected from the group consisting of Ti, Zr, and Hf.

(Technology 2) The capacitor according to Technology 1, wherein the composite oxide has a composition represented by Cs_{α}X_{β}W_{γ}O_{δ}, where
X is at least one selected from the group consisting of Ti, Zr, and Hf

$$0.9 \leq α \leq 1.1 , 0.25 \leq β \leq 1 , 1 \leq γ \leq 2 , and \\ 5.5 \leq δ \leq 6.5 .$$

(Technology 3) The capacitor according to Technology 1 or 2, wherein the composite oxide has a pyrochlore-type crystal structure.

(Technology 4) A dielectric material for a capacitor, the dielectric material comprising a composite oxide is composed of
O,
Cs;
W; and
at least one selected from the group consisting of Ti, Zr, and Hf.

(Technology 5) An electrical circuit comprising the capacitor according to any one of Technologies 1 to 3.

(Technology 6) A circuit board comprising the capacitor according to any one of Technologies 1 to 3.

(Technology 7) A device comprising the capacitor according to any one of Technologies 1 to 3.

### EXAMPLES

Hereinafter, the present disclosure will now be described in detail with reference to Examples. The Examples described below are merely illustrative, and the present disclosure is not limited to the Examples described below.

### Evaluation of Relative Dielectric Constant

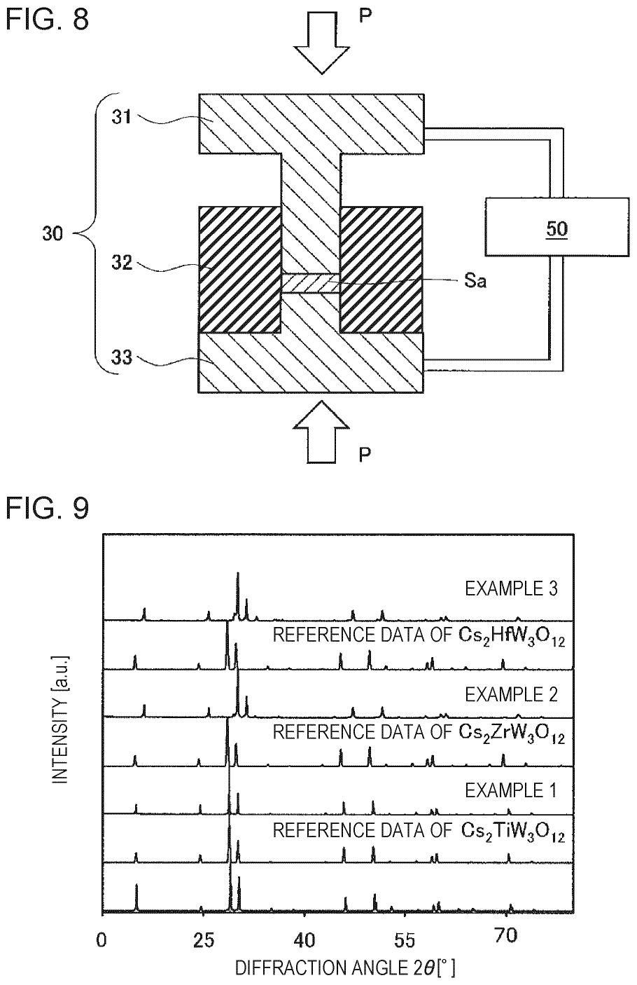

FIG. 8 is a schematic diagram illustrating a manner of evaluating a relative dielectric constant of dielectric materials of Examples. As illustrated in FIG. 8, a pressure molding die assembly 30 included an upper punch 31, a die 32, and a lower punch 33. The upper punch 31 and the lower punch 33 were each formed of stainless steel, which was electron-conductive. The die 32 was formed of polycarbonate, which was electrically insulating.

The relative dielectric constant of the dielectric materials of the Examples was measured with the pressure molding die assembly 30 in the following manner. In a dry atmosphere with a dew point of −30° C. or less, powdered dielectric materials of the Examples were each charged into the pressure molding die assembly 30 to provide a sample Sa. A pressure P of 300 MPa was applied to the sample Sa with the upper punch 31 and the lower punch 33 in the pressure molding die assembly 30. In the state in which the pressure P was applied to the sample Sa, the upper punch 31 and the lower punch 33 were connected to a potentiostat 50 which was equipped with a frequency response analyzer. As the potentiostat 50, a VersaSTAT4, manufactured by Princeton Applied Research Corporation was used. The upper punch 31 was connected to a working electrode and a voltage measurement terminal of the potentiostat 50. The lower punch 33 was connected to a counter electrode and a reference electrode of the potentiostat 50. An impedance of the sample Sa was measured at room temperature (22° C.) by an electrochemical impedance spectroscopy method. In this manner, a relative dielectric constant ε′ᵣ at 1 MHz of the samples of the Examples was measured. The relative dielectric constant ε′ᵣ was determined based on the measured value of the capacitance, which was measured for each of the samples, a thickness of the sample Sa, and areas of the electrodes. The measured relative dielectric constant ε′ᵣ was corrected with a pellet fill factor f, according to equation (1), to determine a relative dielectric constant εᵣ of the dielectric materials. In equation (1), ε_{Air} is a relative dielectric constant of air, which is taken as 1 in the calculation of the relative dielectric constant εᵣ. The fill factor f was calculated according to equation (2). ρₚₑₗₗₑₜ is a density of the sample Sa, and ρ is a density determined by the crystal structure of the dielectric material. The results are shown in Table 1.

$$log {ε}_{r} = ( log {ε}_{r}^{′} - ( 1 - f ) log {ε}_{Air} ) / f \qquad equation ( 1 )$$

$$f = {ρ}_{pellet} / ρ \qquad equation ( 2 )$$

### Evaluation of Dielectric Breakdown Field

A calculated value of a dielectric breakdown field E of the dielectric materials of the Examples and Comparative Examples was obtained based on a bandgap E_{g} which was obtained from first-principles calculation. The dielectric breakdown field E was calculated according to equation (3a) and equation (3b) shown below, with reference to Wang, Li-Mo. “Relationship between Intrinsic Breakdown Field and Bandgap of Materials.”, 2006 25th International Conference on Microelectronics. IEEE, 2006. In the equations below, the units of E and E_{g} are V/nm and eV, respectively. The calculation results are shown in Table 1.

$$E = 1.36 \times {( {E}_{g} / 4 )}^{3} ( if {E}_{g} < 4 ) \qquad equation ( 3 a )$$

$$E = 1. 36 \times ( {E}_{g} / 4 ) ( if {E}_{g} \geq 4 ) \qquad equation ( 3 b )$$

### Evaluation of Energy Density

A calculated value of an energy density W of the dielectric materials of the Examples was obtained according to equation (4) shown below, based on the relative dielectric constant εᵣ of the dielectric materials which was determined from the measurement results, and the dielectric breakdown field E [V/nm] which was calculated as described above. In equation (4), ε₀ is a dielectric constant of a vacuum, and the unit of the energy density W is [Wh/liter (L)].

$$W = ( 1 / 7.2 ) \times 1 {0}^{12} \cdot {ε}_{0} \cdot {ε}_{r} \cdot {( E )}^{2} \qquad equation ( 4 )$$

### Analysis of Crystal Structure

An X-ray diffraction (XRD) measurement was performed on the dielectric material of Example 1 to identify its crystal structure. The X-ray used in the measurement was Cu-Kα radiation, and the measurement was performed under a dry argon atmosphere. FIG. 9 is a graph showing XRD patterns of the dielectric materials of the Examples. In the graph, the horizontal axis represents a diffraction angle 2θ, and the vertical axis represents an intensity of X-ray diffraction. FIG. 9 shows reference data of X-ray diffraction patterns of Cs₂HfW₃O₁₂, Cs₂ZrW₃O₁₂, and Cs₂TiW₃O₁₂. These reference data were retrieved from the Inorganic Crystal Structure Database (ICSD).

### Example 1

A raw material powder (3 gram) was prepared. The raw material powder contained Cs₂CO₃, TiO₂, and WO₃ so as to satisfy a condition of molar amount of Cs₂CO₃: molar amount of TiO₂: molar amount of WO₃=1:1:3. The raw material powder was ground and mixed in a mortar. The mixed powder obtained in this manner was placed in a pressure molding die assembly and pressed at a pressure of 20 MPa to form a pellet. The obtained pellet was sintered in air at 850° C. for 80 hours. The sintered pellet was ground again in the mortar to provide a powdered dielectric material of Example 1. The dielectric material of Example 1 had a composition represented by CsTi_{0.5}W_{1.5}O₆.

### Example 2

A raw material powder (3 gram) was prepared. The raw material powder contained Cs₂CO₃, ZrO₂, and WO₃ which so as to satisfy a condition of molar amount of Cs₂Co₃: molar amount of ZrO₂: molar amount of WO₃=1:1:3. The raw material powder was ground and mixed in a mortar. The mixed powder obtained in this manner was placed in a pressure molding die assembly and pressed at a pressure of 20 MPa to form a pellet. The obtained pellet was sintered in air at 850° C. for 80 hours. The sintered pellet was ground again in the mortar. The obtained powder was placed in the pressure molding die assembly again and pressed at a pressure of 20 MPa to form a pellet. The obtained pellet was sintered in air at 900° C. for 15 hours. The sintered pellet was ground again in the mortar to provide a powdered dielectric material of Example 2. The dielectric material of Example 2 had a composition represented by CsZr_{0.5}W_{1.5}O₆.

### Example 3

A raw material powder (3 gram) was prepared. The raw material powder contained Cs₂CO₃, HfO₂, and WO₃ so as to satisfy a condition of molar amount of Cs₂CO₃: molar amount of HfO₂: molar amount of WO₃=1:1:3. The raw material powder was ground and mixed in a mortar. The mixed powder obtained in this manner was placed in a pressure molding die assembly and pressed at a pressure of 20 MPa to form a pellet. The obtained pellet was sintered in air at 850° C. for 80 hours. The sintered pellet was ground again in the mortar. The obtained powder was placed in the pressure molding die assembly again and pressed at a pressure of 20 MPa to form a pellet. The obtained pellet was sintered in air at 900° C. for 15 hours. The sintered pellet was ground again in the mortar to provide a powdered dielectric material of Example 3. The dielectric material of Example 3 had a composition represented by CsHf_{0.5}W_{1.5}O₆.

### Comparative Example 1

Calculated values of the dielectric breakdown field E and the energy density W of Nd₂Hf₂O₇ were obtained according to equations (3a), (3b) and (4), by using the relative dielectric constant εᵣ and the bandgap E_{g} of Nd₂Hf₂O₇ that are described in the ICSD. The results are shown in Table 1.

### Comparative Example 2

Calculated values of the dielectric breakdown field E and the energy density W of BaTa₂O₆ were obtained according to equations (3a), (3b), and (4), by using the relative dielectric constant εᵣ and the bandgap E_{g} of BaTa₂O₆ that are described in the ICSD. The results are shown in Table 1.

### Comparative Example 3

Calculated values of the dielectric breakdown field E and the energy density W of BaTa₂O₆ were obtained according to equations (3a), (3b), and (4), by using the relative dielectric constant εᵣ and the bandgap E_{g} of BaTa₂O₆ that are described in the ICSD. The results are shown in Table 1.

As shown in Table 1, the dielectric materials of the Examples had a higher relative dielectric constant than the composite oxides of the Comparative Examples. In addition, it was suggested that the dielectric materials of the Examples had a high dielectric breakdown field E. Accordingly, it was suggested that dielectric materials including a composite oxide containing Cs, W, and at least one selected from the group consisting of Ti, Zr, and Hf are advantageous in terms of increasing the capacitance and the dielectric breakdown field of capacitors.

As indicated by FIG. 9, the XRD patterns of the dielectric materials of Examples 1, 2, and 3 respectively matched the reference data of the X-ray diffraction patterns of Cs₂TiW₃O₁₂, Cs₂ZrW₃O₁₂, and Cs₂HfW₃O₁₂ retrieved from the ICSD. This suggested that the composite oxides included in the dielectric materials of the Examples had a pyrochlore-type crystal structure.

TABLE 1

| | | Relative | Bandgap | | |
|---|---|---|---|---|---|
| | | Dielectric Constant | (calculated | | |
| | | (measured value | value or value | Dielectric | Energy |
| | | or value reported | reported in | Breakdown | Density |
| | Composition | in literature) | literature) [eV] | Field [V/nm] | [Wh/L] |
| Example 1 | CsTi_{0.5}W_{1.5}O₆ | 350 | 4.286 | 14.57 | 199 |
| Example 2 | CsZr_{0.5}W_{1.5}O₆ | 85 | 4.629 | 15.74 | 154 |
| Example 3 | CsHf_{0.5}W_{1.5}O₆ | 75 | 4.624 | 15.72 | 164 |
| Comparative | Nd₂Hf₂O₇ | 45 | 5.905 | 20.08 | 116 |
| Example 1 | | | | | |
| Comparative | BaTa₂O₆ | 50 | 3.739 | 11.11 | 134 |
| Example 2 | | | | | |
| Comparative | BaNd₂O₆ | 47 | 3.921 | 12.81 | 103 |
| Example 3 | | | | | |

The capacitors of the present disclosure are useful in terms of the capacitance and the dielectric breakdown field.

What is claimed is:

1. A capacitor comprising:
a first electrode;
a second electrode; and
a dielectric material disposed between the first electrode and the second electrode, the dielectric material comprising a composite oxide,
wherein
the composite oxide is composed of:
O,
Cs,
W, and
at least one selected from the group consisting of Ti, Zr, and Hf.

2. The capacitor according to claim 1, wherein
the composite oxide has a composition represented by Cs_{α}X_{β}W_{γ}O_{δ}, where
X is at least one selected from the group consisting of Ti, Zr, and Hf,
$$0.9 \leq α \leq 1.1 , 0.25 \leq β \leq 1 , 1 \leq γ \leq 2 , and \\ 5.5 \leq δ \leq 6.5 .$$

3. The capacitor according to claim 1, wherein
the composite oxide has a pyrochlore crystal structure.

4. A dielectric material for a capacitor, the dielectric material comprising a composite oxide is composed of
O;
Cs;
W; and
at least one selected from the group consisting of Ti, Zr, and Hf.

5. An electrical circuit comprising the capacitor according to claim 1.

6. A circuit board comprising the capacitor according to claim 1.

7. A device comprising the capacitor according to claim 1.
